(19) United States
(12) Patent Application Publication
(10) Pub. No.: US 2012/0188953 A1
(43) Pub. Date: Jul. 26, 2012

(54) COORDINATED MULTIPOINT TRANSMISSION AND RECEPTION METHOD AND COORDINATED MULTIPOINT TRANSMISSION AND RECEPTION SYSTEM

(75) Inventors: Seuck Ho WON, Daejeon (KR); Sun Hyoung Kwon, Seoul (KR); Ho Kyom Kim, Daejeon (KR); Jong Soo Lim, Daejeon (KR); Jin Woo Hong, Daejeon (KR)

(73) Assignee: Electronics and Telecommunications Research Institute, Daejeon (KR)

(21) Appl. No.: 13/351,541

(22) Filed: Jan. 17, 2012

(30) Foreign Application Priority Data
Jan. 20, 2011 (KR) 10-2011-0005825
Jan. 27, 2011 (KR) 10-2011-0008429
Jan. 4, 2012 (KR) 10-2012-0000931

(51) Int. Cl. H04W 72/04

(52) U.S. Cl. 370/329

(57) ABSTRACT

Provided are a coordinated multipoint transmission and reception method and a coordinated multipoint transmission and reception system for performing the same. In the coordinated multipoint transmission and reception method, a first point and a second point participating in the coordinated multipoint transmission exchange resource allocation information for coordinated multipoint transmission, allocate resources for coordinated multipoint transmission not to overlap each other based on the exchanged resource allocation information, and perform the coordinated multipoint transmission using the allocated resources. Accordingly, use efficiency of radio resources can be improved and embodying complexity can be reduced.

### CLAIM FOR PRIORITY

This application claims priority to Korean Patent Application No. 10-2011-0005825 filed on Jan. 20, 2011, No. 10-2011-0008429 filed on Jan. 27, 2011 and No. 10-2012-0000931 filed on Jan. 4, 2012 in the Korean Intellectual Property Office (KIPO), the entire contents of which are hereby incorporated by reference.

### BACKGROUND

1. Technical Field

Example embodiments of the present invention relate in general to a radio communication system, and more specifically, to a coordinated multipoint transmission and reception method and a coordinated multipoint transmission and reception system for performing the same.

2. Related Art

Future radio communication systems are expected to have a very high data transmission rate with wired communication systems. With this trend, a coordinated multipoint (hereinafter referred to as “CoMP”) transmission and reception method in a 3^{rd} Generation Partnership Project (3GPP) Long Term Evolution (LTE)-Advanced system, which is a 4^{th} generation mobile communication system, is being standardized.

The CoMP transmission and reception method refers to a transmission and reception operation between two or more points (e.g., sites, cells, base stations, or distributed antennas) and one or more terminals. CoMP transmission and reception methods may be classified into uplink CoMP transmission and downlink CoMP transmission.

In the uplink CoMP transmission, a terminal transmits a signal to multiple geographically remote points, which joint-process the signal received from the terminal. In the uplink CoMP transmission, the terminal need not recognize from which network node a signal has been transmitted or to what process a received signal has been subjected, but need only recognize what downlink signaling is provided in connection with uplink transmission. Accordingly, the uplink CoMP transmission may be introduced without greatly changing a standard of a radio interface.

The downlink CoMP transmission refers to a plurality of geographically remote points cooperatively transmitting a signal to one or more terminals. In 3GPP TR 36.814, a downlink CoMP category is classified into joint processing (JP) and coordinated beamforming/coordinated scheduling (CB/CS). Further, JP is classified into joint transmission (JT) in which multiple points simultaneously perform physical downlink shared channel (PDSCH) transmission and dynamic cell selection (DSC) in which one point performs the PDSCH transmission.

The JT is a concept of distributed antennas in which data is available in respective transmission points in a CoMP cooperating set, in which it is necessary to know exact information of a radio channel, and its performance is very fluid, for example, due to delay and a prediction error. Further, the JT has a drawback in that there is a great amount of information that must be exchanged between transmission points, which overloads a backhaul connecting the respective points.

The DSC method is a method of performing PDSCH transmission in one point in a CoMP cooperating set at a specific moment. An amount of information that must be exchanged between points is small and exact information need not be shared, but its performance may be degraded due to a feedback delay.

The CB/CS method is a method of transmitting data from only a serving cell to a terminal at a specific moment. This method has drawbacks in that it is difficult to expect large capacity since the method is a passive method for avoiding inter-cell interference, and a burden on a backhaul may be imposed since user scheduling/beamforming is determined by cooperation between cells corresponding to a CoMP cooperating set.

### SUMMARY

Accordingly, example embodiments of the present invention are provided to substantially obviate one or more problems due to limitations and disadvantages of the related art.

Example embodiments of the present invention provide a coordinated multipoint transmission and reception method that is capable of being easily embodied and maximizing resource use efficiency.

Example embodiments of the present invention also provide a coordinated multipoint transmission and reception system for performing the coordinated multipoint transmission and reception method.

In some example embodiments, a coordinated multipoint transmission and reception method includes exchanging, by a first point, resource allocation information with a second point participating in coordinated multipoint transmission; allocating, by the first point, resources for coordinated multipoint transmission not to overlap resources allocated by the second point based on the exchanged resource allocation information; and performing, by the first point, coordinated multipoint transmission using the allocated resources.

Here, exchanging, by a first point, resource allocation information with a second point participating in coordinated multipoint transmission may include exchanging at least one of common resource information that can be allocated for coordinated multipoint transmission by the first and second points and resource information allocated for coordinated multipoint transmission by the second point from among the common resources.

Here, allocating resources for the coordinated multipoint transmission may include allocating, by the first point, resources not allocated for coordinated multipoint transmission by the second point among the common resources, for coordinated multipoint transmission.

In other example embodiments, a coordinated multipoint transmission and reception method includes exchanging, by a first point, resource allocation information with a second point participating in coordinated multipoint transmission; allocating, by the first point, resources for coordinated multipoint transmission from among common resources that can be allocated for coordinated multipoint transmission by the first point and the second point based on the exchanged resource allocation information; and performing, by the first point, the coordinated multipoint transmission using the allocated resources.

In still other example embodiments, a coordinated multipoint transmission and reception method includes allocating, by a first point, resources for coordinated multipoint transmission of the first point and a second point; transmitting, by the first point, resource allocation information and data to be transmitted by the second point among data received from a network, to the second point; and performing, by the first point, the coordinated multipoint transmission using the allocated resources.

Here, allocating, by a first point, resources for coordinated multipoint transmission of the first point and a second point includes allocating, by the first point, the resources for coordinated multipoint transmission to be the same between the first point and the second point.

In yet other example embodiments, a method for coordinated multipoint transmission and reception in a first point and a second point includes allocating, by the first point, resources for coordinated multipoint transmission based on channel quality information reported from a terminal; performing, by the second point, resource allocation based on a specific pattern prescribed for the terminal; and performing, by the first point and the second point, coordinated multipoint transmission to the terminal using the allocated resources.

Here, allocating, by the first point, resources for coordinated multipoint transmission based on channel quality information reported from a terminal may include transmitting, by the first point, data to be subjected to the coordinated multipoint transmission by the second transmission point among data received from a network, to the second point.

In yet other example embodiments, a coordinated multipoint transmission and reception system includes a first point configured to allocate resources for coordinated multipoint transmission; and a second point configured to exchange resource allocation information with the first point and allocate resources for coordinated multipoint transmission not to overlap the resources allocated by the first point based on the exchanged resource allocation information.

Here, the first point and the second point may exchange at least one of common resource information that can be allocated for coordinated multipoint transmission and resource information to be allocated for coordinated multipoint transmission by the first point and the second point among the common resources. The first point and the second point may allocate the resources for coordinated multipoint transmission not to overlap each other from among the common resources.

In yet other example embodiments, a coordinated multipoint transmission and reception system includes a first point configured to allocate resources for coordinated multipoint transmission; and a second point configured to exchange resource allocation information with the first point and allocate resources for coordinated multipoint transmission from among common resources allocated for coordinated multipoint transmission by the first point and the second point, based on the exchanged resource allocation information.

In yet other example embodiments, a coordinated multipoint transmission and reception system includes a first point configured to allocate resources for coordinated multipoint transmission in consideration of at least one other point participating in the coordinated multipoint transmission, and transmitting resource allocation information and data for coordinated multipoint transmission to the at least one other point; and a second point among the at least one other point configured to perform the coordinated multipoint transmission using the resource allocation information and the data for coordinated multipoint transmission transmitted from the first point.

Here, the first point may allocate the resources for coordinated multipoint transmission to be the same among all the points participating in the coordinated transmission.

In yet other example embodiments, a coordinated multipoint transmission and reception system includes a first point configured to allocate resources for coordinated multipoint transmission based on channel quality information reported from a terminal; and a second point configured to allocate resources for coordinated multipoint transmission based on a specific pattern prescribed for the terminal, wherein the first and second points perform coordinated multipoint transmission to the terminal using the resources allocated for coordinated multipoint transmission.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram for explaining a coordinated multipoint transmission and reception method according to an example embodiment of the present invention;

FIG. 2 is a flowchart illustrating a coordinated multipoint transmission and reception method according to an example embodiment of the present invention;

FIG. 3 is a flowchart illustrating a coordinated multipoint transmission and reception method according to another example embodiment of the present invention;

FIG. 4 is a conceptual diagram for explaining a coordinated multipoint transmission and reception method according to another example embodiment of the present invention;

FIG. 5 is a flowchart illustrating a coordinated multipoint transmission and reception method according to another example embodiment of the present invention shown in FIG. 4;

FIG. 6 is a flowchart illustrating a coordinated multipoint transmission and reception method according to another example embodiment of the present invention;

FIG. 7 is a conceptual diagram for explaining a coordinated multipoint transmission and reception method according to another example embodiment of the present invention; and

FIG. 8 is a flow diagram illustrating a coordinated multipoint transmission and reception method according to another example embodiment of the present invention shown in FIG. 7.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A “terminal” used herein may be referred to as mobile station (MS), mobile terminal (MT), user terminal, user equipment (UE), user terminal (UT), wireless terminal, access terminal (AT), subscriber unit, subscriber station (SS), wireless device, radio communication device, wireless transmit/receive unit (WTRU), mobile node, mobile, etc.

Further, a “transmission point” or a “base station” used herein generally refers to a fixed point communicating with a terminal, and may be referred to as base station, node-B, enode-B, base transceiver system (BTS), access point, remote radio head (RRH), etc.

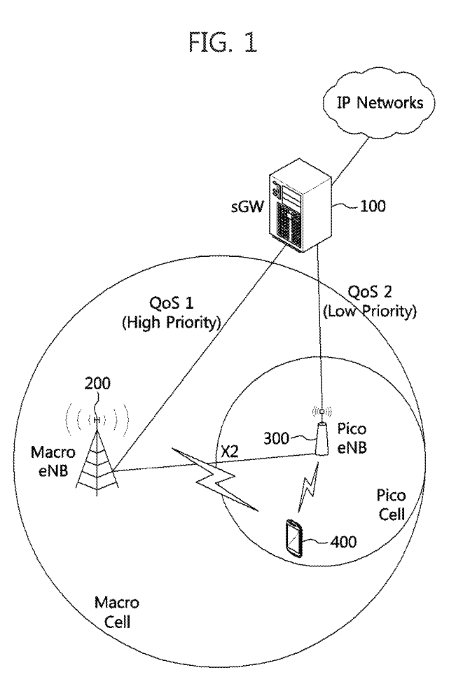

FIG. 1 is a conceptual diagram for explaining a coordinated multipoint transmission and reception method according to an example embodiment of the present invention, in which a method of processing coordinated multipoint transmission and reception using non-conflict resources (coordinated multipoint joint processing using non-conflict resources) is illustrated.

In FIG. 1, for convenience of explanation, a coordinated multipoint transmission and reception environment in a heterogeneous network deployment environment in which a macro cell and a pico cell are deployed to overlap each other is shown by way of example, but the example embodiment of the present invention is not limited thereto.

Referring to FIG. 1, a radio communication system for performing the coordinated multipoint transmission and reception method may include a serving gateway (S-GW) 100, a first base station 200 for serving a macro cell, and a second base station 300 for serving a pico cell. The first base station 200 and the second base station 300 may be connected to the serving gateway 100 via an S1 interface, and may be connected to each other via an X2 interface and exchange control information and/or data necessary for coordinated multipoint transmission and reception.

For Internet protocol (IP) packets of multiple bearer streams transmitted from an IP network, the serving gateway 100 transmits the packet having a quality of service (QoS) condition most suitable for each base station to the base station in consideration of a traffic situation, a radio link situation, and/or the like of each base station.

Here, the serving gateway 100 may determine the QoS condition of the packet based on information contained in a type of service (TOS) field of a packet header when the received packet is an IPv4 type, and may determine the QoS condition of the packet based on a traffic class field of the packet header when the received packet is an IPv6 type. The QoS condition of the packet may be confirmed by reading information such as a QoS class identifier (QCI) and/or an allocation and retention priority (ARP) from the corresponding field of the packet, and such functions may be embodied using functions defined in standards such as 3GPP LTE.

That is, the serving gateway 100 determines the QoS condition of the received packet by referencing the TOS field or the traffic class field according to the type of the received packet, and delivers the packet having a QoS condition most suitable for a current situation of each base station in consideration of traffic, a radio link situation and/or the like of each base station to the base station.

For example, when the traffic, the radio link situation and/or the like of the first base station 200 is assumed to be better than that of the second base station 300, the serving gateway 100 may transmit the received packet to the first base station 200 when the QoS of the received packet has high priority or is at a high Qos level, and may transmit the received packet to the second base station 300 when the QoS of the received packet has low priority or is at a low QoS level.

Meanwhile, when a predetermined base station receiving the packet from the serving gateway 100 transmits the packet to the other base station (e.g. the second base station 300) via the backhaul interface, the base station may transmit a packet having the most suitable QoS condition in consideration of the traffic, the radio link situation, and/or the like of the transmission target base station.

The first base station 200 and the second base station 300 allocate resources not to overlap each other from among a resource set that can be allocated to a coordinated multipoint transmission target terminal 400, and then transmit data to the terminal 400 using the allocated resources to thereby perform the coordinated multipoint transmission. For such resource allocation, the first base station 200 and the second base station 300 exchange necessary information via the backhaul interface, and a MAC scheduler of each base station performs coordinated scheduling based on the exchanged information.

Specifically, when a set of resource elements that can be allocated to the terminal 400 in a resource set available, in common, to both the macro cell and the pico cell is defined as C_T, a set in C_T that can be allocated in the macro cell is defined as C_M, and a set in C_T that can be allocated in the pico cell is defined as C_P, the first base station 200 and the second base station 300 allocate the resources so that C_M and C_P do not have common elements. This may be represented as Equation 1.

When C_{—}T={r_{—}1,r_{—}2, . . . ,r_{—}n},

C_{—}M={r_{—}1,r_{—}2, . . . ,r_{—}n},

C_{—}P={r_(i+1),r_(i+2), . . . ,r_{—}n}, and

C_{—}T=C_{—}M∪C_{—}P and C_{—}M∩C_{—}P=Ø Equation 1

In Equation 1, r_n denotes an index of an allocable resource element. That is, each of the first base station 200 and the second base station 300 allocates resources and performs scheduling to satisfy Equation 1.

The indexes of the allocable resources are sequentially arranged in Equation 1 and the first base station 200 and the second base station 300 sequentially allocate the resources not to overlap each other, but this is only for convenience of illustration and the first base station 200 and the second base station 300 may allocate the resources not to overlap each other using a variety of methods.

For example, the first base station 200 and the second base station 300 may alternately allocate resource elements in the resource set C_T that can be allocated to the terminal 400, as shown in Equation 2.

When C_{—}T={r_{—}1,r_{—}2, . . . ,r_{—}n},

C_{—}M={r_{—}1,r_{—}3, . . . ,r_(n−1)},

C_{—}P={r_{—}2,r_{—}4, . . . ,r_{—}n}, and

C_{—}T=C_{—}M∪C_{—}P and C_{—}M∩C_{—}P=Ø Equation 2

Meanwhile, the first base station 200 and the second base station 300 may dynamically adjust concrete values (i.e., C_M and C_P) of Equation 1 or 2 according to a situation of a radio channel, a distance between each base station and the terminal 400, a fading situation, or the like. The adjustment may be applied once when a link to the terminal 400 is established, in order to reduce a control load.

Further, the first base station 200 and the second base station 300 independently perform scheduling according to the allocated C_M and C_P, and perform scheduling so that a delay deviation of OFDM symbols transmitted from each base station and received by the terminal 400 is included in a cyclic prefix (CP) period.

In addition, the first base station 200 and the second base station 300 can flexibly utilize a spectrum by performing carrier aggregation on a plurality of component carriers located in different bands when the allocable frequency bands are in non-continuous bands.

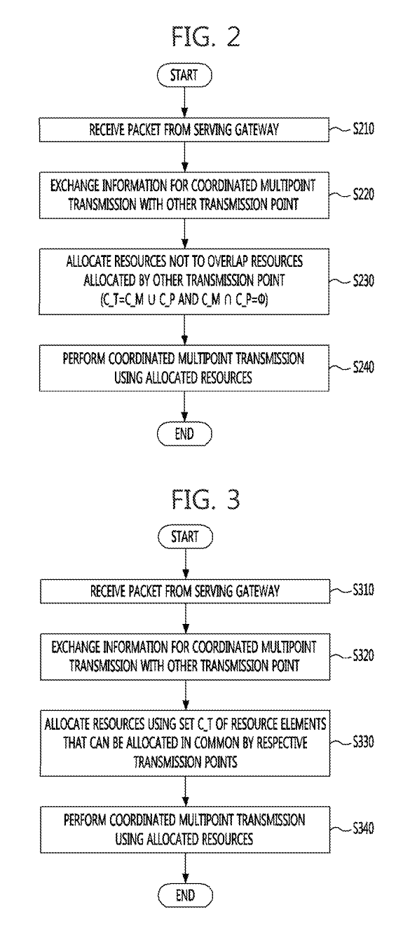

FIG. 2 is a flowchart illustrating a coordinated multipoint transmission and reception method according to an example embodiment of the present invention, in which a resource allocation process performed in each transmission point participating in coordinated multipoint transmission and reception is illustrated.

Referring to FIG. 2, first, respective transmission points (e.g., the first base station 200 and the second base station 300 of FIG. 1) receive a target packet to be subjected to coordinated multipoint transmission from the serving gateway 100 (step S210).

Each transmission point then exchanges information for coordinated multipoint transmission with at least one other point participating in the coordinated multipoint transmission (step S220). Here, each transmission point may exchange a set C_T of resource elements that can be allocated by all the transmission points, resource information (e.g., C_M) to be allocated by each transmission point, and resource information (e.g., C_P) to be allocated by the other transmission point, for coordinated multipoint transmission to the predetermined terminal 400. Alternatively, the transmission points do not directly exchange resource allocation information for coordinated multipoint transmission as described above, but may provide the information to the serving gateway 100 and then receive necessary information from the serving gateway 100.

Each transmission point then allocates resources in the set C_T of resource elements that can be allocated to the predetermined terminal 400 in common by the transmission points not to overlap resources allocated by the other transmission point based on the resource allocation information of the other transmission point acquired as described above (step S230). That is, each transmission point allocates resources for coordinated multipoint transmission to satisfy Equation 1.

Each transmission point then performs the coordinated multipoint transmission to the terminal 400 using the allocated resources (step S240).

FIG. 3 is a flowchart illustrating a coordinated multipoint transmission and reception method according to another example embodiment of the present invention.

The coordinated multipoint transmission and reception method according to another example embodiment of the present invention is characterized by processing coordinated multipoint transmission and reception using free conflict resources (coordinated multipoint Joint processing using free conflict resources).

Hereinafter, the coordinated multipoint transmission and reception method according to another example embodiment of the present invention will be described in detail with reference to FIG. 3. First, in a heterogeneous network deployment environment as shown in FIG. 1, respective transmission points (e.g., the first base station 200 and the second base station 300) receive a packet from the serving gateway 100 (step S310).

Each transmission point then exchanges information for coordinated multipoint transmission with at least one other point participating in the coordinated multipoint transmission (step S320). Here, each transmission point may exchange information of a set C_T of resource elements that can be allocated by both the transmission points, for coordinated multipoint transmission to a predetermined terminal 400. Alternatively, the respective transmission points do not directly exchange resource allocation information for coordinated multipoint transmission as described above with each other, but may provide the information to the serving gateway 100 and receive necessary information from the serving gateway 100.

Each transmission point then allocates resources using a set C_T of resource elements that can be allocated to the predetermined terminal 400 in common by the transmission points, based on the resource allocation information acquired as described above (step S330).

Each transmission point then performs the coordinated multipoint transmission to the terminal 400 using the allocated resources (step S340).

As the resources are allocated using the set C_T of common resource elements that can be allocated by the respective transmission points as described above, resources that the terminal 400 receives from the respective transmission points may conflict. In this case, the terminal 400 may eliminate interference of the conflicting resources using spatial multiplex decoding, a multiple-input multiple-output (MIMO) decoding method, or the like. Here, the terminal 400 may be configured to recognize information for resources allocated to the terminal 400 among the received resources and resources causing the interference, from control signals transmitted from the respective transmission points in advance.

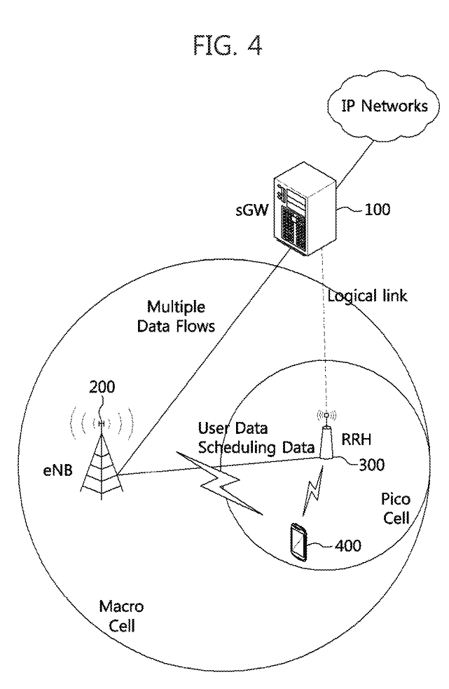

FIG. 4 is a conceptual diagram for explaining a coordinated multipoint transmission and reception method according to another example embodiment of the present invention, in which a method of processing coordinated multipoint transmission and reception using predetermined non-conflict resources (coordinated multipoint joint processing using predetermined non-conflict resources) is illustrated.

Referring to FIG. 4, a radio communication system for performing the coordinated multipoint transmission and reception method may include a serving gateway 100, a first base station 200 for serving a macro cell, and a second base station 300 for serving a pico cell. The first base station 200 may be connected to the serving gateway 100 via an S1 interface. The first base station 200 and the second base station 300 may be connected to each other via an X2 interface and the second base station 300 may receive control information and/or data necessary for coordinated multipoint transmission and reception from the first base station 200. Here, the second base station 300 may be configured of a radio remote head (RRH), installed in a hot spot region, and connected to the serving gateway 100 via a logical link.

The serving gateway 100 transmits IP packets of multiple bearer streams transmitted from an IP network, to the first base station 200.

The first base station 200 receiving the coordinated multipoint transmission target packet from the serving gateway 100 performs all scheduling for performing the coordinated multipoint transmission with the second base station 300 (i.e., RRH), and then transmits scheduling information and coordinated multipoint transmission target user data to the second base station 300.

The second base station 300 performs coordinated multipoint transmission to the terminal 400 using the scheduling information for coordinated multipoint transmission and the user data received from the first base station 200.

In the coordinated multipoint transmission and reception method according to another example embodiment of the present invention as shown in FIG. 4, any one transmission point (e.g., a macro base station) among a plurality of transmission points participating in the coordinated multipoint transmission exclusively performs all scheduling necessary for coordinated multipoint transmission, and then transmits scheduling information and data to be used for coordinated multipoint transmission to other transmission points.

Here, since the transmission point that performs scheduling for coordinated multipoint transmission can recognize not only user data to be transmitted by the transmission point, but also user data to be transmitted by the other transmission point, the interference can be further reduced using a variety of a known coding scheme (e.g., dirty paper coding).

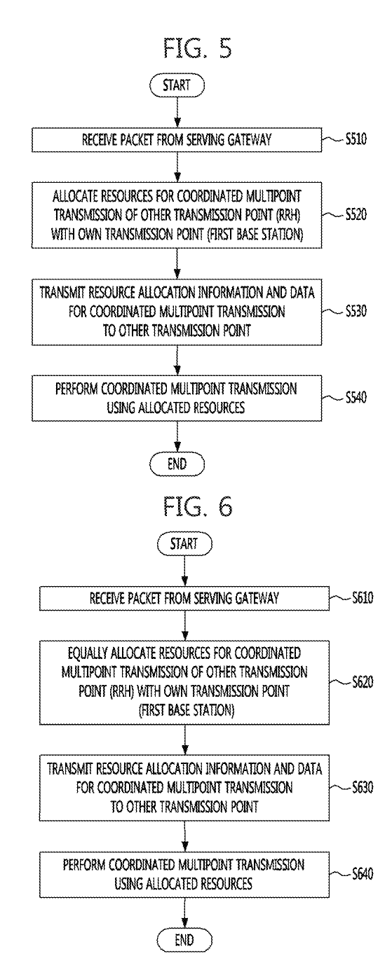

FIG. 5 is a flowchart illustrating a coordinated multipoint transmission and reception method according to another example embodiment of the present invention shown in FIG. 4, in which a resource allocation process performed in a specific transmission point is illustrated.

First, in the heterogeneous network deployment environment as shown in FIG. 4, a specific transmission point (e.g., the first base station 200) receives a coordinated multipoint transmission target packet from the serving gateway 100 (step S510).

The specific transmission point then performs resource allocation for coordinated multipoint transmission of at least one other point (e.g., RRH) participating in the coordinated multipoint transmission with the specific transmission point (step S520).

The specific transmission point then transmits resource allocation information and user data to be transmitted by the other transmission point to the other transmission point (step S530).

Each transmission point then performs the coordinated multipoint transmission to the terminal 400 using the allocated resources (step S540).

As described above, in the coordinated multipoint transmission and reception method according to another example embodiment of the present invention, a specific transmission point among a plurality of transmission points participating in the coordinated multipoint transmission allocates resources so that interference does not occur in consideration of user data to be transmitted by the other transmission point. Accordingly, quality of a received signal can be improved, and since the terminal 400 may not use power for eliminating the interference from received data, power use efficiency can be improved.

FIG. 6 is a flowchart illustrating a coordinated multipoint transmission and reception method according to another example embodiment of the present invention. This method is mostly similar to the coordinated multipoint transmission and reception methods described with reference to FIGS. 4 and 5, but differs from the methods described with reference to FIGS. 4 and 5 in that coordinated multipoint transmission and reception is processed using predetermined conflict resources (coordinated multipoint joint processing using predetermined conflict resources).

Referring to FIG. 6, in the heterogeneous network deployment environment as shown in FIG. 4, a specific transmission point (e.g., the first base station 200) receives a coordinated multipoint transmission target packet from the serving gateway 100 (step S610).

The specific transmission point then performs resource allocation for coordinated multipoint transmission of at least one other point (e.g., RRH) participating in the coordinated multipoint transmission with the specific transmission point (step S620). Here, the specific transmission point allocates resources so that both the specific transmission point (i.e., the first base station 200) and the other transmission point (i.e., RRH) use the same resources.

The specific transmission point then transmits resource allocation information and user data to be transmitted by the other transmission point to the other transmission point (step S630).

Each transmission point then performs coordinated multipoint transmission to the terminal 400 using the allocated resources (step S640).

All the transmission points transmit user data using the same resources through the resource allocation as described above, thereby increasing spectrum use efficiency. The terminal 400 can eliminate interference of conflicting resources using spatial multiplex decoding, a MIMO decoding method, or the like.

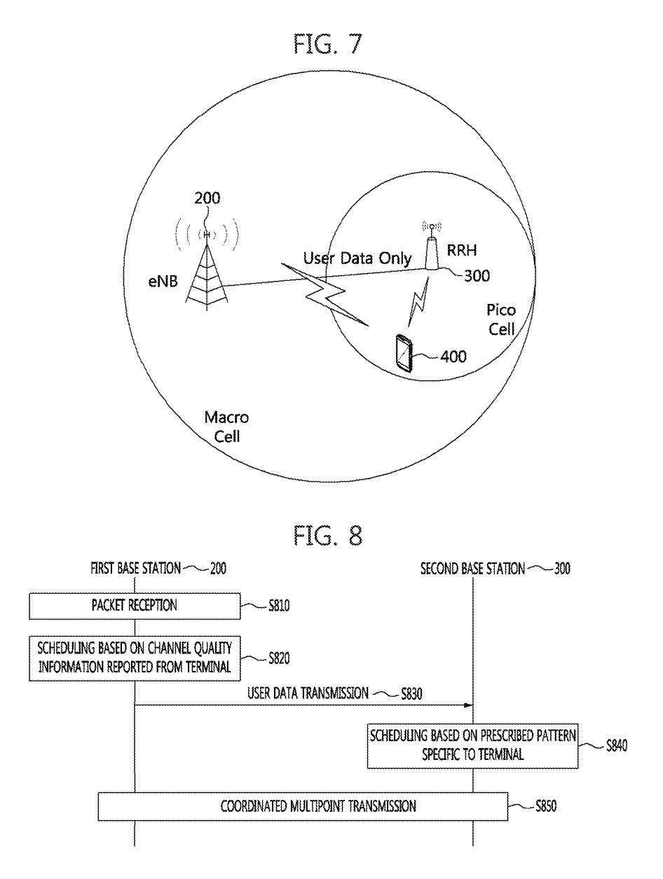

FIG. 7 is a conceptual diagram for explaining a coordinated multipoint transmission and reception method according to another example embodiment of the present invention, in which a method of processing coordinated multipoint transmission and reception using non-determined free conflict resources (coordinated multipoint joint processing using non-determined free conflict resources) is illustrated.

Referring to FIG. 7, the coordinated multipoint transmission and reception method according to another example embodiment of the present invention may be applied to a heterogeneous network deployment environment in which a first base station 200 serves a macro cell, and a pico cell served by a second base station 300 is deployed to overlap in a hot spot region within the macro cell. Here, the second base station 300 may include an RRH.

The first base station 200 performs resource allocation based on a channel situation or quality reported by a terminal 400. Here, the first base station 200 performs scheduling corresponding to a channel environment of the terminal 400 based on channel quality indicator (CQI) information that is reported by the terminal 400 each time a periodic or specific event occurs.

Meanwhile, the second base station 300 performs scheduling separately from the first base station 200 based on a prescribed terminal-specific pattern (UE-specific pattern).

Accordingly, as shown in FIG. 7, the first base station 200 transmits only user data to be transmitted by the second base station 300 rather than its own resource allocation information, to the second base station 300.

Further, according to the resource allocation method as described above, interference of resources that conflict from the point of view of the terminal 400 can be eliminated using a method such as spatial multiplex decoding (or MIMO decoding).

FIG. 8 is a flow diagram illustrating a coordinated multipoint transmission and reception method according to another example embodiment of the present invention shown in FIG. 7, in which operation of the first base station 200 and the second base station 300 participating in coordinated multipoint communication is illustrated. In FIG. 8, the first base station 200 may be a macro base station, and the second base station 300 may be an RRH.

Referring to FIG. 8, first, the first base station 200 receives a packet from the serving gateway 100 of a core network (EPC: Evolved Packet Core) (step S810), and performs scheduling based on channel quality information reported from the terminal 400 (step S820). Here, the terminal 400 may measure channel quality according to a prescribed cycle and report the channel quality information to the first base station 200, which is a serving base station, or may report channel quality information corresponding to occurrence of a prescribed specific event to the first base station 200. Further, the channel quality information may be a CQI.

The first base station 200 then transmits user data on which the second base station 300 must perform the coordinated multipoint transmission, to the second base station 300 (step S830).

Meanwhile, the second base station 300 participating in the coordinated multipoint communication performs scheduling based on a prescribed pattern specific to the terminal 400 (UE-specific pattern) (step S840). Here, the pattern specific to the terminal 400 refers to a scheduling pattern prescribed according to the coordinated multipoint transmission target terminal 400, and may include a resource allocation pattern, a modulation and coding scheme, or the like.

When scheduling for the coordinated multipoint transmission target terminal 400 is completed in the first base station 200 and the second base station 300 as described above, the first base station 200 and the second base station 300 perform the coordinated multipoint transmission to the terminal 400 (step S850).

The resource allocation methods according to the example embodiments of the present invention as described above may be applied to a macro cell site having its own cell ID and a pico cell site (or a point) having no own cell ID, a macro-pico having their own cell IDs and connected to each other via an optical fiber transmission path, a macro-macro cell site, a macro-pico having their own cell IDs and connected to each other via an X2 interface, a macro-macro cell site, or the like, as well as the heterogeneous network deployment environment.

Further, the resource allocation methods according to the example embodiments of the present invention are not particularly limited in the number of antennas of the transmission points and/or the terminal 400, but are assumed to operate in a communication environment including a maximum of 8×8 transmission and reception antennas. Further, the number of RRH antennas is assumed to be 1, 2 or 4.

According to the coordinated multipoint transmission and reception method and the coordinated multipoint transmission and reception system as described above, the respective points participating in the coordinated multipoint transmission allocate resources not to overlap each other using resources that can be allocated by all the points or allocate resources using the resources that can be allocated by all the points, and then perform the coordinated multipoint transmission using the allocated resources. Alternatively, any one of points participating in the coordinated multipoint transmission equally or differently allocates resources in consideration of an interference or radio environment of all the points, and then performs the coordinated multipoint transmission using the allocated resources. Alternatively, a predetermined point among points participating in the coordinated multipoint transmission allocates resources based on channel quality information reported from a terminal, another point allocates resources using a pattern prescribed for a specific terminal, and the points performs the coordinated multipoint transmission using the allocated resources.

Accordingly, in a heterogeneous network deployment environment, the complexity of embodying an apparatus for coordinated multipoint transmission and reception can be reduced and resource use efficiency can be improved.

Further, according to a variety of cell characteristics in the heterogeneous network deployment environment, traffic can be adaptively adjusted and an amount of information exchanged between points participating in the coordinated multipoint transmission can be minimized. Further, quality of service can be improved by performing scheduling corresponding to a characteristic of a radio link.

While the example embodiments of the present invention and their advantages have been described in detail, it should be understood that various changes, substitutions and alterations may be made herein without departing from the scope of the invention.

What is claimed is:

1. A coordinated multipoint transmission and reception method comprising:
exchanging, by a first point, resource allocation information with a second point participating in coordinated multipoint transmission;
allocating, by the first point, resources for coordinated multipoint transmission not to overlap resources allocated by the second point based on the exchanged resource allocation information; and
performing, by the first point, coordinated multipoint transmission using the allocated resources.

2. The method of claim 1, wherein exchanging, by a first point, resource allocation information with a second point participating in coordinated multipoint transmission comprises:
exchanging at least one of common resource information that can be allocated for coordinated multipoint transmission by the first and second points and resource information allocated for coordinated multipoint transmission by the second point from among the common resources.

3. The method of claim 2, wherein allocating resources for the coordinated multipoint transmission comprises:
allocating, by the first point, resources not allocated for coordinated multipoint transmission by the second point among the common resources, for coordinated multipoint transmission.

4. A coordinated multipoint transmission and reception method comprising:
exchanging, by a first point, resource allocation information with a second point participating in coordinated multipoint transmission;
allocating, by the first point, resources for coordinated multipoint transmission from among common resources that can be allocated for coordinated multipoint transmission by the first point and the second point based on the exchanged resource allocation information; and
performing, by the first point, the coordinated multipoint transmission using the allocated resources.

5. A coordinated multipoint transmission and reception method comprising:
allocating, by a first point, resources for coordinated multipoint transmission of the first point and a second point;
transmitting, by the first point, resource allocation information and data to be transmitted by the second point among data received from a network, to the second point; and
performing, by the first point, the coordinated multipoint transmission using the allocated resources.

6. The method of claim 5, wherein allocating, by a first point, resources for coordinated multipoint transmission of the first point and a second point comprises:
allocating, by the first point, the resources for coordinated multipoint transmission to be the same between the first point and the second point.

7. A method for coordinated multipoint transmission and reception in a first point and a second point, the method comprising:
allocating, by the first point, resources for coordinated multipoint transmission based on channel quality information reported from a terminal;
performing, by the second point, resource allocation based on a specific pattern prescribed for the terminal; and
performing, by the first point and the second point, coordinated multipoint transmission to the terminal using the allocated resources.

8. The method of claim 7, wherein allocating, by the first point, resources for coordinated multipoint transmission based on channel quality information reported from a terminal comprises:
transmitting, by the first point, data to be subjected to the coordinated multipoint transmission by the second transmission point among data received from a network, to the second point.

9. A coordinated multipoint transmission and reception system comprising:
a first point configured to allocate resources for coordinated multipoint transmission; and
a second point configured to exchange resource allocation information with the first point and allocate resources for coordinated multipoint transmission not to overlap the resources allocated by the first point based on the exchanged resource allocation information.

10. The system of claim 9, wherein the first point and the second point exchange at least one of common resource information that can be allocated for coordinated multipoint transmission and resource information to be allocated for coordinated multipoint transmission by the first point and the second point among the common resources.

11. The system of claim 10, wherein the first point and the second point allocate the resources for coordinated multipoint transmission not to overlap each other from among the common resources.

12. A coordinated multipoint transmission and reception system comprising:
a first point configured to allocate resources for coordinated multipoint transmission; and
a second point configured to exchange resource allocation information with the first point and allocate resources for coordinated multipoint transmission from among common resources allocated for coordinated multipoint transmission by the first point and the second point, based on the exchanged resource allocation information.

13. A coordinated multipoint transmission and reception system comprising:
a first point configured to allocate resources for coordinated multipoint transmission in consideration of at least one other point participating in the coordinated multipoint transmission, and transmitting resource allocation information and data for coordinated multipoint transmission to the at least one other point; and
a second point among the at least one other point configured to perform the coordinated multipoint transmission using the resource allocation information and the data for coordinated multipoint transmission transmitted from the first point.

14. The system of claim 13, wherein the first point allocates the resources for coordinated multipoint transmission to be the same among all the points participating in the coordinated transmission.

15. A coordinated multipoint transmission and reception system comprising:
a first point configured to allocate resources for coordinated multipoint transmission based on channel quality information reported from a terminal; and
a second point configured to allocate resources for coordinated multipoint transmission based on a specific pattern prescribed for the terminal,
wherein the first and second points perform coordinated multipoint transmission to the terminal using the resources allocated for coordinated multipoint transmission.
